(19) United States
(12) Patent Application Publication
(10) Pub. No.: US 2025/0277526 A1
(43) Pub. Date: Sep. 4, 2025

(54) SEAL TO BE DISPOSED BETWEEN A STRUCTURAL COMPONENT AND AN ENVIRONMENT MODULE

(71) Applicant: Deere & Company, Moline, IL (US)

(72) Inventors: James M. FRETT, Peosta, IA (US); Andy VIZE, Dubuque, IA (US)

(73) Assignee: Deere & Company, Moline, IL (US)

(21) Appl. No.: 18/593,004

(22) Filed: Mar. 1, 2024

(51) Int. Cl. B60H 1/00

(52) U.S. Cl. CPC F16J 15/027; B60H 1/00514

(57) ABSTRACT

A system includes a seal including a first opening disposed between a first portion of the structural component and a first portion of the environment module to create a negative pressure zone of the system and a second opening disposed between a second portion of the structural component and a second portion of the environment module to create a positive pressure zone of the system, the positive pressure zone surrounding the negative pressure zone.

### FIELD OF THE DISCLOSURE

Example embodiments relate to seals for placement between structural components (including, for example, vehicle cabs) and environment modules to be attached thereto.

### BACKGROUND

Construction or utility vehicles (such as tractors) often have cabs that include environment modules (e.g., heating-ventilation-air conditioning units). Seals are often placed between the body of the cab and the environment module, for example, to limit water and/or dust ingress and to generally improve the performance of the environment module.

### SUMMARY

In various aspects, the present disclosure provides an example seal for use between a structural component and an environment module attached thereto.

In at least one example embodiment, the seal may include a main body having opposing first and second sides and including one or more openings and a bellow structure extending from the first side of the main body, the bellow structure including a curvature relative to a major axis of the seal.

In at least one example embodiment, the bellow structure may be a continuous bellow structure extending along a perimeter of the first side.

In at least one example embodiment, the bellow structure may be a first bellow structure and the seal may further include a second bellow structure extending around a first opening of the one or more openings.

In at least one example embodiment, the seal may further include a third bellow structure extending around a second opening of the one or more openings.

In at least one example embodiment, the one or more openings may further include a third opening and a substantially planar portion of the main body may extend between a side of the third opening and the first bellow structure, a first end of the substantially planar portion having a first distance from the first bellow structure, and a second end of the substantially planar portion having a second distance from the first bellow structure, where the second distance is greater than the first distance.

In at least one example embodiment, the seal may include a metal plate defining the one or more openings, the metal plate being overmolded with a sealing material that defines the bellow structure.

In at least one example embodiment, the sealing material may have a durometer range greater than or equal to about 40 to less than or equal to about 70.

In at least one example embodiment, the seal may further include a plurality of coupling apertures extending through the main body.

In at least one example embodiment, the seal may have an average resting thickness greater than or equal to about 25 millimeters to less than or equal to about 40 millimeters.

In various aspects, the present disclosure provides another example seal for use between a structural component and an environment module attached thereto.

In at least one example embodiment, the seal may include a first opening surrounded or defined by a first bellow structure, a second opening surrounded or defined by a second bellow structure, and a third bellow structure surrounding the first and second bellow structures, the third bellow structure including a curvature relative to a major axis of the seal.

In at least one example embodiment, the seal may further include a third opening and a substantially planar portion of the seal extends between a side of the third opening and the first bellow structure, a first end of the substantially planar portion having a first distance from the first bellow structure, and a second end of the substantially planar portion having a second distance from the first bellow structure, where the second distance is greater than the first distance.

In at least one example embodiment, the seal may further include a fourth bellow structure surrounding or defining the third opening.

In at least one example embodiment, the seal may further include a fourth opening defining a positive pressure zone.

In at least one example embodiment, the seal may include a metal plate defining the first opening and the second opening, the metal plate being overmolded with a sealing material that defines the first, second, and third bellow structures.

In at least one example embodiment, the seal may have an average resting thickness greater than or equal to about 25 millimeters to less than or equal to about 40 millimeters.

In various aspects, the present disclosure provides another example seal for use between a structural component and an environment module attached thereto.

In at least one example embodiment, the seal may include one or more metal plates defining a main body having one or more openings and a sealing material overmolding the main body and extending from one side thereof to form a bellow structure, the bellow structure including a curvature relative to a major axis of the seal.

In at least one example embodiment, the bellow structure may extend along a perimeter of the one side of the main body and the seal may further include a second bellow structure extending around a first opening of the one or more openings.

In at least one example embodiment, the seal may further include a third bellow structure extending around a second opening of the one or more openings.

In at least one example embodiment, the seal may have an average resting thickness greater than or equal to about 25 millimeters to less than or equal to about 40 millimeters.

In various aspects, the present disclosure provides a system having a structural component and an environment module.

In at least one example embodiment, the system includes a seal including a first opening disposed between a first portion of the structural component and a first portion of the environment module to create a negative pressure zone of the system and a second opening disposed between a second portion of the structural component and a second portion of the environment module to create a positive pressure zone of the system, the positive pressure zone surrounding the negative pressure zone.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1 is a perspective view of an example vehicle including a seal disposed between an environment module and a cab of a vehicle in accordance with at least one example embodiment of the present disclosure.

FIG. 2A is a partial perspective side view of the vehicle of FIG. 1 showing the seal as disposed between the environment module and the cab of the vehicle in accordance with at least one example embodiment of the present disclosure.

FIG. 2B is an exploded view of FIG. 2A in accordance with at least one example embodiment of the present disclosure.

FIG. 3A is a front perspective view of the seal illustrated in FIGS. 1-2B in accordance with at least one example embodiment of the present disclosure.

FIG. 3B is a rear perspective view of the seal illustrated in FIGS. 1-3A in accordance with at least one example embodiment of the present disclosure.

FIG. 3C is an exploded view of the seal illustrated in FIGS. 1-3B in accordance with at least one example embodiment of the present disclosure.

FIG. 4A is a side view of the seal illustrated in FIGS. 1-3C as coupled to the environment module in accordance with at least one example embodiment of the present disclosure.

FIG. 4B is a front view of the seal illustrated in FIGS. 1-4A as coupled to the environment module in accordance with at least one example embodiment of the present disclosure.

FIG. 5 is a rear view of the seal illustrated in FIGS. 1-4B as coupled to the cap in accordance with at least one example embodiment of the present disclosure.

### DETAILED DESCRIPTION

Some detailed example embodiments are disclosed herein. However, specific structural and functional details disclosed herein are merely representative for the purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, component, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” specify the presence of stated features, integers, steps, operations, and/or elements, but do not preclude the presence or addition of one or more other features, integers, steps, operations, elements, and/or groups thereof.

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

At least some example embodiments of the present disclosure provide seals for use between structural components (including, for example, vehicle cabs) and environment modules (e.g., heating-ventilation-air condition unit) attached thereto.

As used herein, vehicle may include, for example, an automotive vehicle and/or an agricultural vehicle and/or a mining vehicle and/or a construction vehicle and/or a utility vehicle. The vehicle may include, for example, backhoe loaders, tractors, planters, sprayers, bulldozers, forklifts, steam rollers, cranes, haul truck, underground graders, rock breakers, and the like.

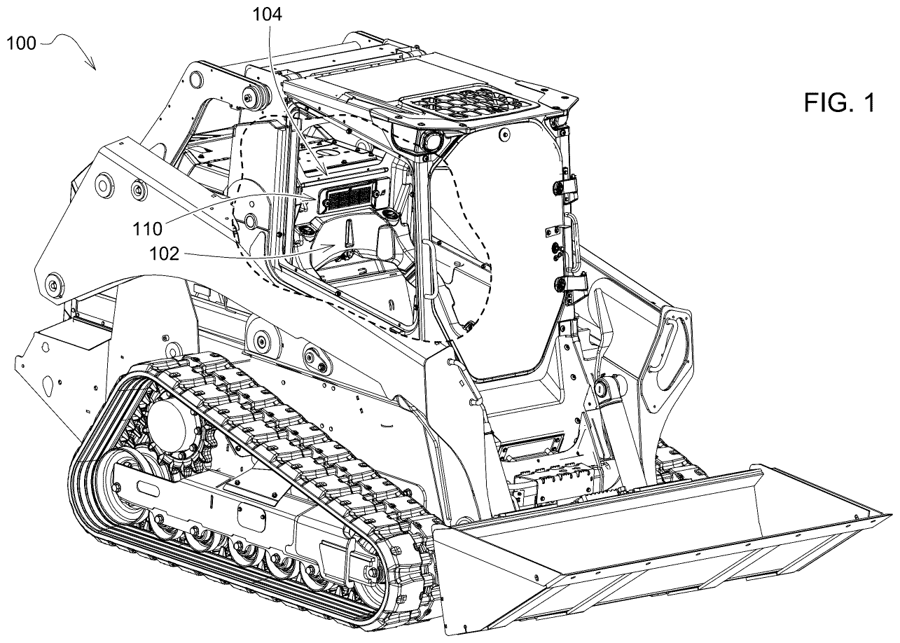

FIG. 1 is a perspective view of an example vehicle 100 including a seal 110 in accordance with at least one example embodiment of the present disclosure. The seal 110 is disposed between the cab 102 of the vehicle 100 and an environment module 104 attached thereto. The seal 110 is a dynamic seal configured to maintain an appropriate seal between the cab 102 and the environment module 104 during relative movement of the cab 102 and/or environment module 104. Although the vehicle 100 is illustrated as including only a single environment module 104 and a single seal 110 associated therewith, it should be appreciated that, in other example embodiments, vehicles may include two or more environment modules and related seals.

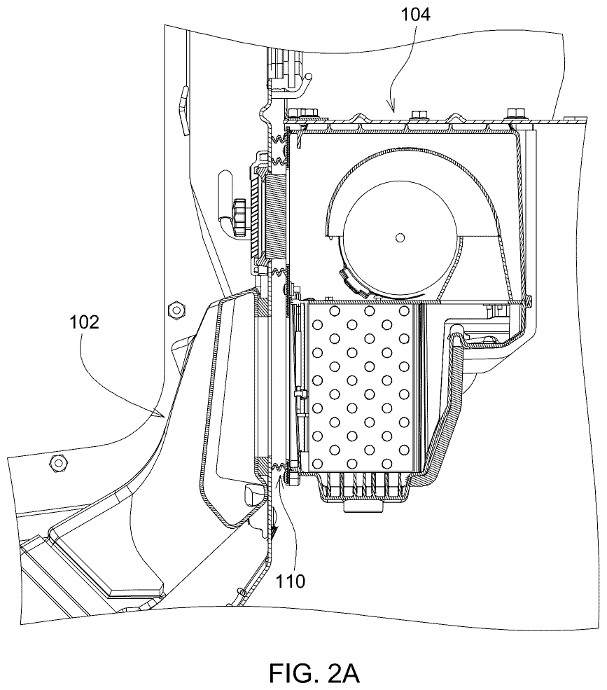

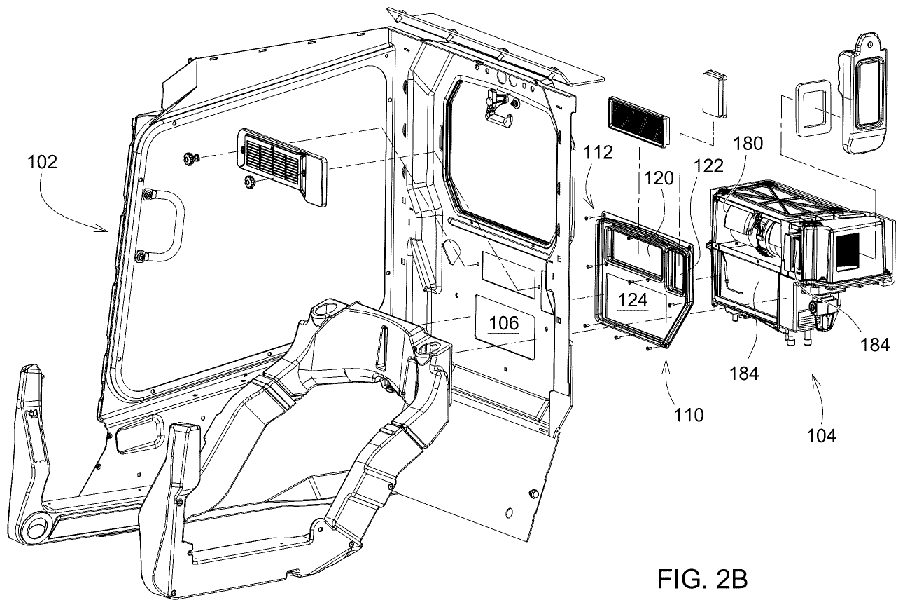

FIG. 2A is a partial perspective side view of the vehicle of FIG. 1, and FIG. 2B is an exploded view of the partial perspective side view of FIG. 2A. As illustrated, a first (or front) side (or surface) 112 of the seal 110 is aligned with and interfaces with the cab 102 (and more particularly, with one or more apertures 106 in the cab 102 configured to join with the environment module 104), while a second (or rear) side (or surface) 114 of the seal 110 is aligned with and interfaces with (e.g., couples to) the environment module 104. As illustrated, the seal 110 includes a plurality of openings 120, 122, 124 configured to align with different components of the cab 102 and/or environment module 104. For example, in at least one example embodiment, the seal 110 may include three openings: a first opening 120, a second opening 122, and a third opening 124. The first opening 120 of the seal 110 may correspond with respective first sections (or portions) of the cab 102 and environment module 104, the second opening 122 of the seal 110 may correspond with respective second sections (or portions) of the cab 102 and environment module 104, and the third opening 124 of the seal 110 may correspond with respective third sections (or portions) of the cab 102 and environment module 104.

In at least one example embodiment, the first opening 120 of the seal 110 may be configured (e.g., shaped) to align and interface with (i.e., seal against) a cabin recirculation air portion (or section) 170 of the cab 102 and/or a cabin recirculation air portion (or section) 180 of the environment module 104. In at least one example embodiment, the second opening 122 of the seal 110 may be configured (e.g., shaped) to align and interface with (i.e., seal against) a cabin fresh air portion (or section) 172 of the cab 102 and/or a cabin fresh air portion (or section) 182 of the environment module 104. In at least one example embodiment, the third opening 124 of the seal 110 may be configured e.g., shaped) to align and interface with (i.e., seal against) a HVAC module outlet or supply air portion (or section) 174 of the cab 102 and/or a HVAC module outlet or supply air portion (or section) 184 of the environment module 104.

In at least one example embodiment, the first opening 120 of the seal 110 may define a negative pressure region (or portion or zone) relation relative to the outside environment. The negative pressure may be caused by the cabin recirculation air portion (or section) 170 of the cab 102 and/or the cabin recirculation air portion (or section) 180 of the environment module 104. In at least one example embodiment, the second opening 122 of the seal 110 may define another negative pressure region (or portion or zone) relative to the outside environment. The negative pressure may be caused by the cabin fresh air portion (or section) 172 of the cab 102 and/or the cabin fresh air portion (or section) 182 of the environment module 104. In at least one example embodiment, the third opening 124 of the seal may define a positive pressure region (or portion or zone) relative to the outside environment. The positive pressure may be caused by the HVAC module outlet or supply air portion (or section) 174 of the cab 102 and/or the HVAC module outlet or supply air portion (or section) 184 of the environment module 104. In at least one example embodiment, the positive pressure at third opening 123 provides a positive pressure zone that helps to prevent outside environmental air and/or contaminants (e.g., dust, debris) from reaching the first and second openings 120, 122, for example, in the instance of a momentary, or small, lose of the sealing between the cab 102 and the environment module 104 such as in the instances of rapid movement of the cab 102 and/or environment module 104.

Although three openings are illustrated, it should be appreciated that, in various other example embodiment the seal 110 may include one or more openings. For example, in at least one example embodiment, the seal may include four openings, one of the four openings being a communication port having (or defining), for example, a positive pressure, while the three other openings have a negative or neutral pressure.

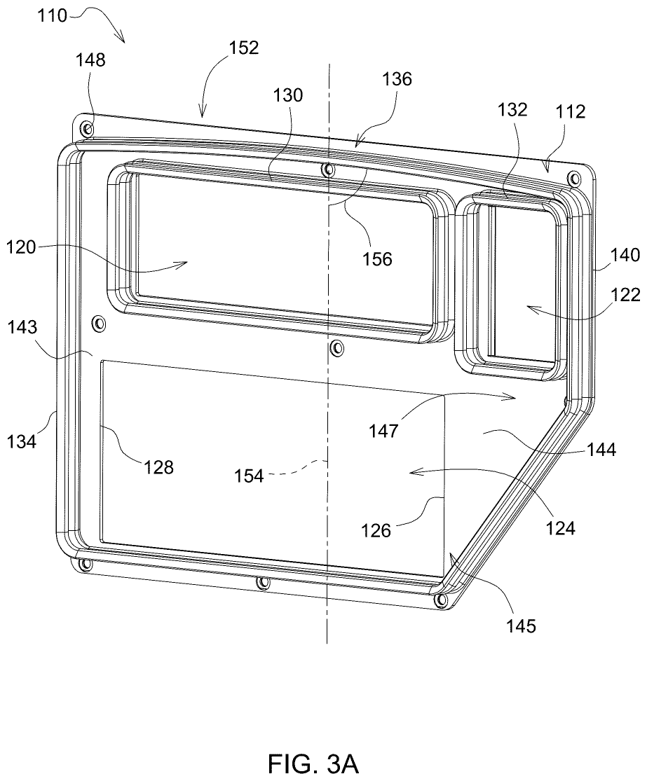

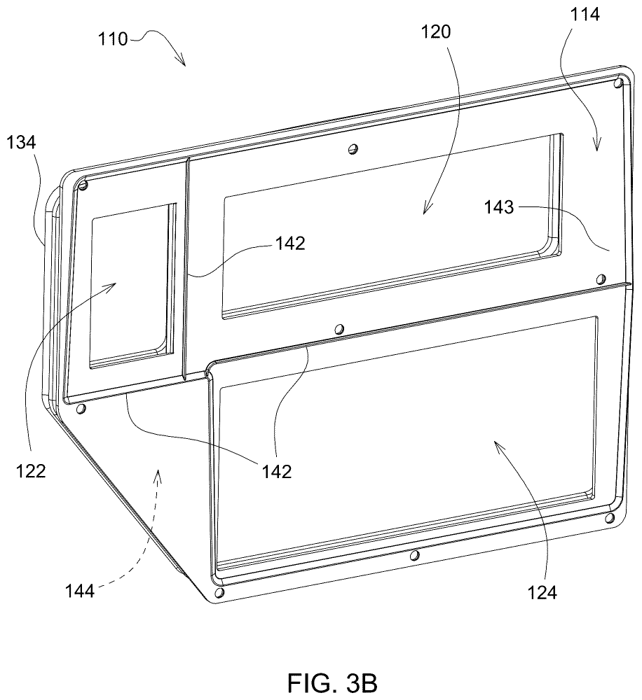

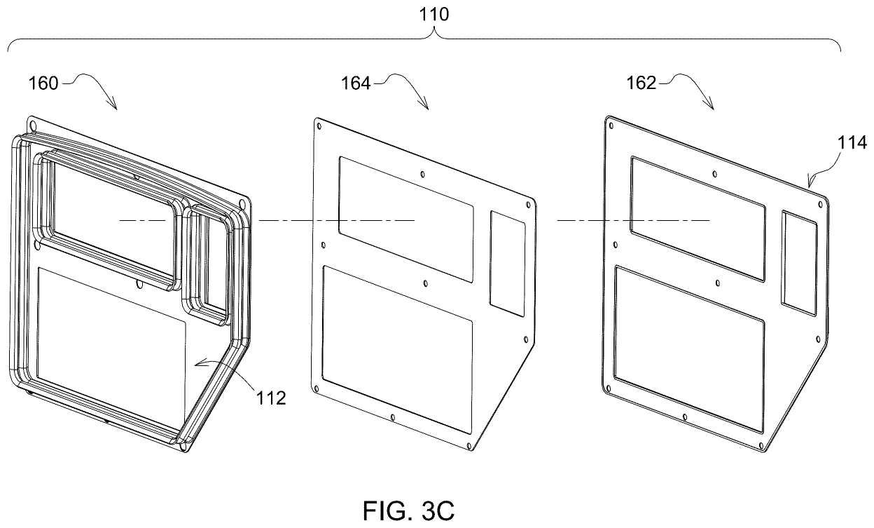

FIG. 3A is a perspective view of the front surface 112 of the seal 110. One or more bellow structures may extend from the front surface 112 of the seal. The one or more bellow structures may be continuous or discontinuous. For example, in at least one example embodiment, as illustrated, a first bellow structure 130 may be a continuous structure that extends from (or defines) portion of the front surface 112 surrounding (or defining) the first opening 120 of the seal 110. In at least one example embodiment, the first bellow structure 130 may be integral to the first opening 120 of the seal 110. In each instance, the first bellow structure 130 provides for flexible sealing around and between a first section of the cab 102 and a first section of the environment module 104 such that movement of the cab 102 and environment module 104 are readily absorbed and tolerated.

In at least one example embodiment, as illustrated, a second bellow structure 132 may be a continuous structure that extends from (or define) a portion of the front surface 112 surrounding (or defining) the second opening 122 of the seal 110. In at least one example embodiment, the second bellow structure 132 may be integral to the second opening 122 of the seal 110. In each instance, the second below structure 132 provides for flexible sealing around and between a second portion of the cab 102 and a second portion of the environment module 104 such that movement of the cab 102 and environment module 104 are readily absorbed and tolerated.

In at least one example embodiment, as illustrated, a third bellow structure 134 may be a continuous structure that extend from (or define) at least a portion of a perimeter 140 of the front surface 112 of the seal 110. The third bellow structure 134 provides for flexible sealing around and between the cab 102 and the perimeter 140 of the environment module 104 such that movement of the cab 102 and environment module 104 are readily absorbed and tolerated.

In at least one example embodiment, as illustrated, the third bellow structure 134 is constructed (or configured) to direct (or shed) possible contaminants (e.g., water) around the same and away from the sealed area. For example, the third bellow structure 134 may include a crown portion 136 having a slight curvature 156 relative to a major axis 154 of the seal 110. The crown portion 136 may be disposed near (or aligned with) a first (or top) portion 152 of the seal 110. The curvature 156 is selected to limit or eliminate low spots where water (or other fluids) may pool regardless of the slope at which the vehicle 100 may be parked and accordingly the angle of the cab 102 and/or environment module 104. The curvature 156 is selected to direct the water (or other fluid) in an assigned direction.

In at least one example embodiment, as illustrated, the third opening 124 may be free of a bellows. The third opening 124 may have a first side 126 and an opposing second side 128. A first distance between the first side 126 of the third opening 124 and the third bellow structure 134 may be greater than a second distance between the second side 128 of the third opening 124 and the third bellow structure 134. In at least one example embodiment, as illustrated in FIG. 3A, a substantially planar portion 144 of a main body 143 of the seal 110 may extend between the first side 126 of the third opening 124 and the third bellow structure 134. The perimeter 140 of the seal may be shaped such that a first end 145 of the substantially planar portion 144 has a first distance from the third bellow structure 134, and a second end 147 of the substantially planar portion 144 has a second distance from the third bellow structure 134. The second distance may be greater than the first distance. In at least one example embodiment, the substantially planar portion may have a general triangular configuration.

Although not illustrated, it should be appreciated that, in at least one example embodiment, another bellow structure may surround or define the third opening 124 of the seal 110. Similar to the first bellow structure 130 and/or the second bellow structure 132, the another bellow structure may extend alone (or define) a wall portion of the seal 110 defining the third opening 124. The another bellow structure may provide for flexible sealing around and between a third portion of the cab 102 and a third portion of the environment module 104 such that movement of the cab 102 and environment module 104 are readily absorbed and tolerated.

Although three bellow structure are illustrated, it should be appreciated that, in at least one example embodiment, the seal 110 may include only one of the first bellow structure 130, the second bellow structure 132, the third bellow structure 134, and the another bellow structure. Likewise, it should be appreciated that, in at least one example embodiment, the seal 110 may include two of the first bellow structure 130, the second bellow structure 132, the third bellow structure 134, and the another bellow structure (e.g., the first bellow structure 130 and the second bellow structure 132 or the first bellow structure 130 and the third bellow structure 134 or the first bellow structure 130 and the another bellow structure or the second bellow structure 132 and the third bellow structure 134 or the second bellow structure 132 and the another bellow structure or the third bellow structure 134 and the another bellow structure).

Although the bellow structures as illustrated are continuous structures, it should be appreciated that, in at least one example embodiment, one or more of the different bellow structures (e.g., the first bellow structure 130 and/or the second bellow structure 132 and/or the third bellow structures 134 and/or the another bellow structure) may be non-continuous structures.

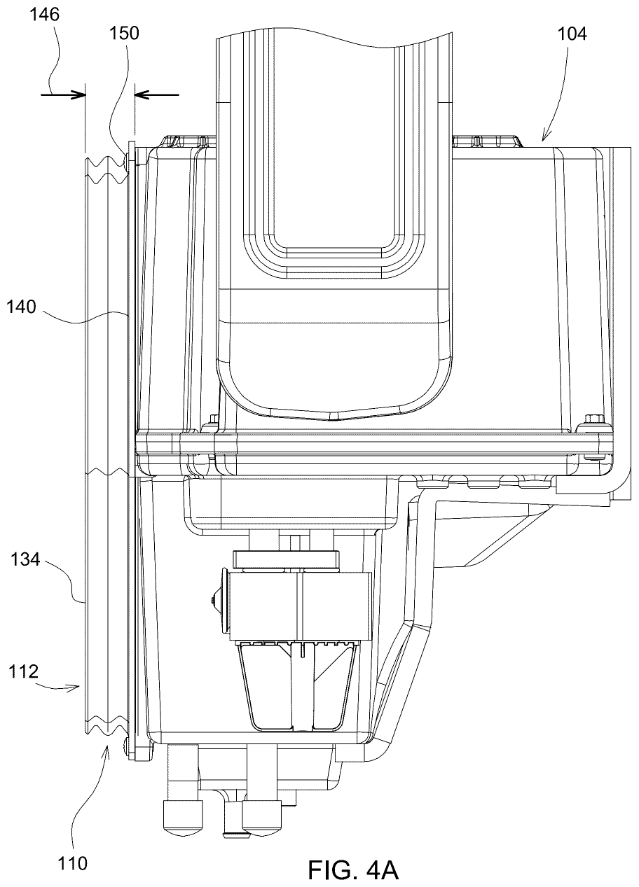

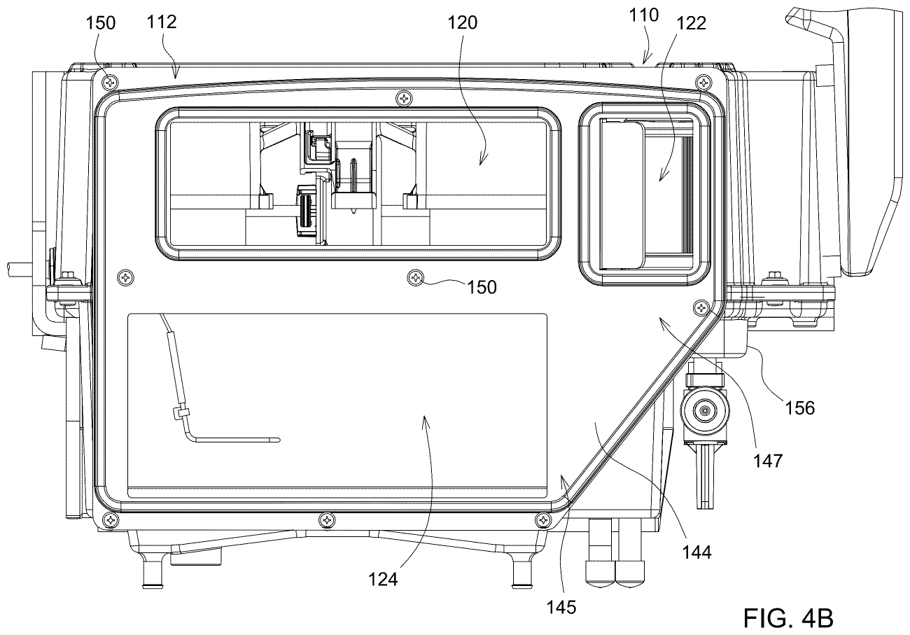

FIG. 3B is a perspective view of the rear surface 114 of the seal 110. As illustrated, in at least one example embodiment, the rear surface 114 of the seal 110 may be generally planar that provides a generally smooth and consistent sealing surface (see, e.g., FIG. 4A). The rear surface 114 may include one or more transition regions 142 that disposed between the different portions the seal 110 including the first, second, and third openings 120, 122, 124, respectively. These transitions regions may provide texturization that helps to improve the sealing between the different portions of the cab 102 and the different portions of the environment module 104.

FIG. 3C is an exploded view of the seal 110. In at least one example embodiment, the seal 110 may include one or more metal plates having or defining one or more openings or apertures (e.g., defining the first, second, and third openings 120, 122, 134) that are overmolded with a sealing material. For example, as illustrated, the seal 110 may include a first half 160 that defines the first side 112 of the seal 110, a second half 162 that defines the second side 114 of the seal 110, and a metal plate 164 disposed therebetween. The first and second halves 160, 162 may include one or more sealing materials and may join together to encase the metal plate 164. In at least one example embodiment, sealing material may have a durometer range greater than or equal to about 40 to less than or equal to about 70. For example, the sealing material may include ethylene propylene diene monomer (EPDM) rubber.

Although only a single metal plate 164 is illustrated in FIG. 3C, it should be appreciated that, in various other example embodiments, one or more metal plates may be encased by the first and second halves 160, 162. The use (or incorporation) of the one or more metal plates 164 helps to ensure a smooth and consistent sealing surface for engaging and interacting with the environment module 104 (see, e.g., FIG. 4A).

FIG. 4A is a side view of the rear surface 114 of the seal 110 as coupled to the environment module 104. As illustrated, the rear surface 114 is substantially flushed with the corresponding surface of the environment module 104. As illustrated, in at least one example embodiment, the seal 110 may have an average thickness 146 (before compression of the environment module 104 and the seal 110 against the cab 102) of greater than or equal to about 25 millimeters to less than or equal to about 40 millimeters, and optionally, about 32 millimeters. In at least one example embodiment, each of the bellow structures 130, 132, 134 may have a height extending from the planar surface of the seal 110 of greater than or equal to about 15 millimeters to less than or equal to about 35 millimeters, and optionally, about 23 millimeters.

FIG. 4B is a front view of the rear surface 114 of the seal 110 as coupled to the environment module 104. As illustrated, the seal 110 has an overall size greater than the corresponding parts (to be sealed) of the cab 102 and/or environment module 104. In at least one example embodiment, the seal 110 is size, for example, to extend positive pressure supply seal around a negative pressure inlet seal (e.g., openings 120, 122), which helps to create a barrier to dust ingress because air (a fluid) always flow from a state of high pressure to a state of low pressure.

The seal 110 may include a plurality of coupling apertures 148 that are configured to receive one or more coupling means (or fasteners) 150 that are configured to secure the seal 110 to the environment module 104. Although the seal 110 is illustrated as including nine coupling apertures 148 configured to receive nine coupling means 150, it should be appreciated that, in at least one example embodiment, the seal 110 may include any number of coupling apertures and the coupling apertures may be configured to receive any number of coupling means.

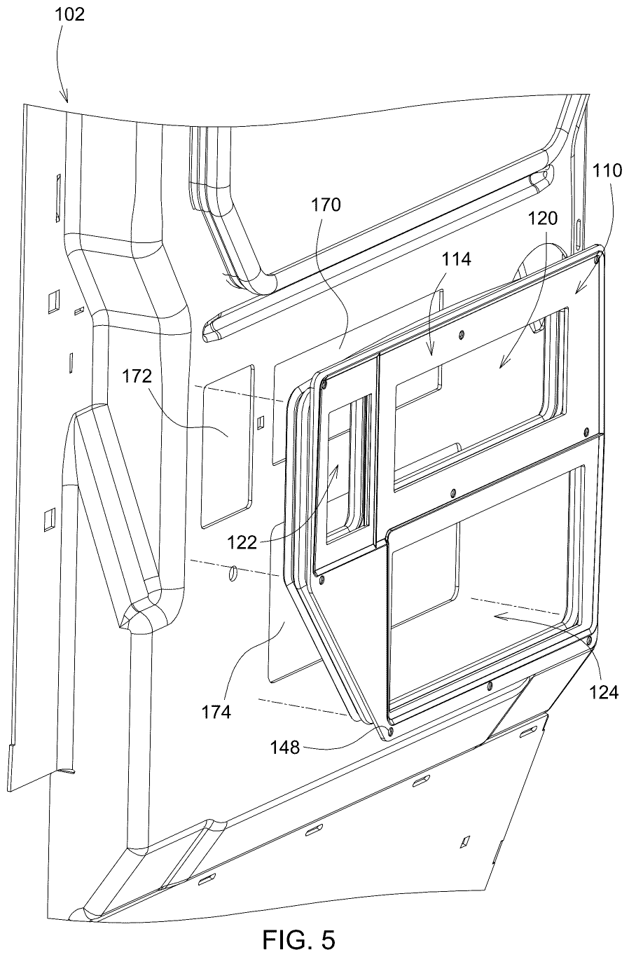

FIG. 5 is a rear view of the seal 110 as aligned with the cab 102. As illustrated, the first opening 120 is aligned with a first aperture of the one or more apertures 106 in the cab 102, the second opening 122 is aligned with a second aperture of the one or more apertures 106 in the cab 102, and the third opening 124 of the one or more apertures 106 in the cab 102.

While some example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

Although described with reference to specific examples and drawings, modifications, additions, and substitutions of example embodiments may be variously made according to the description by those of ordinary skill in the art. For example, the described techniques may be performed in an order different with that of the methods described, and/or elements such as the described system, architecture, devices, circuit, and the like, may be connected or combined to be different from the above-described methods, or results may be appropriately achieved by other elements or equivalents.

1. A seal to be disposed between a structural component and an environment module, the seal comprising:
a main body having opposing first and second sides and including one or more openings; and
a bellow structure extending from the first side of the main body, the bellow structure including a curvature relative to a major axis of the seal.

2. The seal of claim 1, wherein the bellow structure is a continuous bellow structure extending along a perimeter of the first side.

3. The seal of claim 2, wherein the bellow structure is a first bellow structure, and the seal further includes:
a second bellow structure extending around a first opening of the one or more openings.

4. The seal of claim 3, wherein the seal further includes:
a third bellow structure extending around a second opening of the one or more openings.

5. The seal of claim 4, wherein the one or more openings further includes:
a third opening and a substantially planar portion of the main body extends between a side of the third opening and the first bellow structure, a first end of the substantially planar portion having a first distance from the first bellow structure, and a second end of the substantially planar portion having a second distance from the first bellow structure, the second distance being greater than the first distance.

6. The seal of claim 1, wherein the seal includes a metal plate defining the one or more openings, the metal plate being overmolded with a sealing material that defines the bellow structure.

7. The seal of claim 6, wherein the sealing material has a durometer range greater than or equal to about 40 to less than or equal to about 70.

8. The seal of claim 1, wherein the seal further includes:
a plurality of coupling apertures extending through the main body.

9. The seal of claim 1, wherein the seal has an average resting thickness greater than or equal to about 25 millimeters to less than or equal to about 40 millimeters.

10. A seal to be disposed between a structural component and an environment module, the seal comprising:
a first opening surrounded or defined by a first bellow structure;
a second opening surrounded or defined by a second bellow structure; and
a third bellow structure surrounding the first and second bellow structures, the third bellow structure including a curvature relative to a major axis of the seal.

11. The seal of claim 10, wherein the seal further includes:
a third opening and a substantially planar portion of the seal extends between a side of the third opening and the first bellow structure, a first end of the substantially planar portion having a first distance from the first bellow structure, and a second end of the substantially planar portion having a second distance from the first bellow structure, the second distance being greater than the first distance.

12. The seal of claim 11, wherein the seal further includes:
a fourth bellow structure surrounding or defining the third opening.

13. The seal of claim 12, wherein the seal further includes:
a fourth opening defining a positive pressure zone.

14. The seal of claim 10, wherein the seal includes a metal plate defining the first opening and the second opening, the metal plate being overmolded with a sealing material that defines the first, second, and third bellow structures.

15. The seal of claim 10, wherein the seal has an average resting thickness greater than or equal to about 25 millimeters to less than or equal to about 40 millimeters.

16. A seal to be disposed between a structural component and an environment module, the seal comprising:
one or more metal plates defining a main body having one or more openings; and
a sealing material overmolding the main body and extending from one side thereof to form a bellow structure, the bellow structure including a curvature relative to a major axis of the seal.

17. The seal of claim 16, wherein the bellow structure extends along a perimeter of the one side of the main body, and the seal further includes:
a second bellow structure extending around a first opening of the one or more openings.

18. The seal of claim 17, wherein the seal further includes:
a third bellow structure extending around a second opening of the one or more openings.

19. The seal of claim 16, wherein the seal has an average resting thickness greater than or equal to about 25 millimeters to less than or equal to about 40 millimeters.

20. A system having a structural component and an environment module, the system comprising:
a seal including
a first opening disposed between a first portion of the structural component and a first portion of the environment module to create a negative pressure zone of the system; and
a second opening disposed between a second portion of the structural component and a second portion of the environment module to create a positive pressure zone of the system, the positive pressure zone surrounding the negative pressure zone.
